(19) United States
(12) Patent Application Publication
(10) Pub. No.: US 2016/0227740 A1
(43) Pub. Date: Aug. 11, 2016

(54) MULTI LAYERED PET TOY

(71) Applicant: THE KONG COMPANY, LLC, Golden, CO (US)

(72) Inventor: Hoyt Samuel Nunn, Irvine, CA (US)

(21) Appl. No.: 14/616,331

(22) Filed: Feb. 6, 2015

(51) Int. Cl. A01K 11/00; D05B 15/00; D05B 1/02

(52) U.S. Cl. CPC A01K 15/026; D05B 1/02; D05B 15/00

(57) ABSTRACT

A pet or animal toy is constructed of multiple different layers, each layer made of a different type of material to provide the toy with multiple attributes or characteristics. In a preferred embodiment, a pet toy includes a fabric outer layer, an inner noisemaking layer, and one or more inner elastomeric layers. Sufficient thickness or bulk for the toy is achieved by providing relatively thick inner elastomeric layer(s). A noisemaking element or “squeaker” may also be incorporated within the toy. One or more additional layers may be added such as one or more interior fabric layers to add strength to the toy. A method of the invention includes steps for making the toy.

### FIELD OF THE INVENTION

The invention relates to pet toys, and more particularly, to a pet toy having multiple layers made from different materials with a flexible elastomeric core covered by the multiple layers. The invention also includes a method of making the pet toy with multiple layers.

### BACKGROUND OF THE INVENTION

Pet toys are made from many different types of materials. One general category of pet toys is those made of a flexible or elastomeric material, such as rubber. These toys, if made from quality materials, can withstand the biting action of an animal, and can keep an animal occupied for extended periods of time. It is known to place treats in these types of toys to increase the interaction of the animal with the toy. A sound emitting device, often referred to as a “squeaker”, is also known to be placed inside the toy to further stimulate the animal.

Another general category of pet toys are those which may generally be referred to as “plush” toys. These types of toys are made from different types of cloth or fabric, and may also include material woven into strands, such as nylon rope. The plush toy is typically stuffed with a fibrous material, such as polyester stuffing, to provide the toy with an increased thickness or bulk that enables the animal to chew on the toy. Because the fibrous material is not strong or resilient enough to prevent the teeth of the animal from fully penetrating the outer cloth or fabric covering, plush toys are prone to being easily destroyed by the animal simply chewing through the outer covering. A single hole chewed through the outer covering can result in removal of the inner stuffing, and therefore making the toy unfit for further use by the animal. Attempts can be made to re-stuff the toy, but unless the hole(s) are repaired, the stuffing will again be easily removed by the animal. Most pet owners do not take the time and effort required to repair a damaged plush toy, so the plush toy is thrown away. Plush toys may also include squeakers to further stimulate the animal.

Considering the general defects in the prior art mentioned above, there is a need for a pet toy that provides a satisfying chewing experience for the animal, but is durable enough to withstand the biting action of the animal. There is also a need for a pet toy that combines features of both plush toys and flexible rubber/plastic toys to attract a greater percentage of animals, since many prefer only one or the other type of toy. There is also a need for a pet toy incorporating a squeaker device in which the squeaker can be easily removed and replaced if it becomes damaged.

The invention described below provides solutions to many defects in the prior art, yet with a pet toy construction that is robust enough to withstand the prolonged biting action of an animal. The invention also provides a pet toy that is relatively simple in structure, and therefore, can be produced at reasonable costs.

### SUMMARY OF THE INVENTION

The invention includes a pet or animal toy constructed of multiple different layers, each layer made of a different type of material to provide the pet toy with multiple attributes or characteristics. In one preferred embodiment, a pet toy includes a fabric outer or exterior layer, an inner or interior noisemaking layer or noisemaking core, and one or more inner or interior elastomeric layers. The term “fabric” as used herein is intended to cover all types of cloth material, as well as materials that resemble cloth. An example of the fabric outer layer may include a fabric that has a pronounced textured surface, such as corduroy or oxford. The inner noisemaking layer may include one or more sheets of material such as crackle paper. Crackle paper may be generally defined as a plastic polyester film. Commercial strength embossed plastic polyester film will withstand vigorous playing action of an animal. This film produces a loud “crackly” or “crinkly” sound when compressed or otherwise disturbed. The inner elastomeric layer may include a flexible and elastomeric material, such as synthetic or natural rubber, or combinations thereof. Preferably, the crackle paper is placed between or directly adjacent the inner elastomeric layer(s).

In another preferred embodiment, the pet toy may further include a noise making device, such as a squeaker, that is incorporated within the pet toy. According to one aspect of this embodiment, the squeaker may be releasably retained within an internal pocket or sleeve sewn within the pet toy. The internal holding pocket has an opening that may be selectively opened and closed with a closure element, such as hook and pile material.

In another preferred embodiment, the pet toy may further include at least one inner fabric layer made of a fabric that has less texture or is smoother than the fabric outer layer. The inner fabric layer may also have a denser, more robust configuration in order to provide added strength to the pet toy and to limit the penetration of the teeth of an animal as it chews or bites the toy.

The pet toy may be shaped to represent a desired figure, such as a doll, an animal, or an inanimate object. Decorative features may be added to the fabric outer layer to better depict the figure. For example, in one preferred embodiment, the pet toy represents the shape of an animal, and decorative features secured to the first fabric outer layer represent hair, eyes, ears, a nose, and a mouth. Additional decorative features may be secured to the fabric outer layer, such as other types of fabric to represent other exterior features of the depicted figure, to provide the pet toy with different textures that may function to further attract the animal, or to provide additional aesthetic features making the pet toy more attractive to an owner for purchase.

In terms of the relative thicknesses of the layers, one preferred embodiment incorporates inner elastomeric layer(s) that are thicker than the other layers. These elastomeric layer(s) also provide some relative stiffness for the toy to maintain a desired shape. These elastomeric layers are also preferably of a sufficient thickness to allow an animal to bite into and hold the toy. Therefore, according to one aspect of the inner elastomeric layer(s), it replaces the need for traditional stuffing in order to provide bulk to the pet toy, yet the inner layer(s) is much more resilient and therefore more difficult to damage, thereby extending the life of the pet toy. Preferably, the inner elastomeric layer(s) are of a quality that prevents the teeth of an animal from easily penetrating these layer(s). This flexible, elastomeric feature of the invention also may encourage the biting action of an animal, as such may be associated with rubber pet toys.

As mentioned, the inner noisemaking layer generates a crackling sound when the pet toy is handled, which may further serve as a stimulant for the animal to play with the toy. This noisemaking layer, coupled with the squeaker, provides different types of sounds for the animal which may also further encourage the animal to play with the toy.

According to one preferred embodiment, each of the layers may be joined to one another along a periphery of the pet toy, such as by stitching or sewing. Depending upon the shape of the pet toy, the materials making up the layers, and the desired stiffness of the toy, the layers may be selectively stitched or sewn to one another along many different areas both along the periphery of the pet toy, as well as areas within the periphery of the pet toy.

According to another aspect of the invention, a method is provided for making the pet toy. According to one step in the method, front and rear outside or exterior layers are cut to a desired shape corresponding to the figure to be depicted. As mentioned, this material may include corduroy and/or oxford type material.

According to another step in the method, the inner elastomeric layer(s) comprise one or more sheets of rubber (for example a sheet of approximately 2.0 mm thick), and the rubber is cut to create piece(s) in the shape of the pet toy. If two pieces of rubber are cut to form the inner elastomeric layers, one piece may be cut so that it traces a shape of the character to be depicted, but leaves a small border on each side of the shape. For example, if the shape of the character to be depicted is 150 mm wide, a width of the inner rubber piece could be 140 mm, thereby leaving a 5 mm border on each side. Another piece of the sheet rubber is cut so that it also traces the shape of the character, but leaves a larger border around each side the shape. For example, this second sheet could be cut so that it has a 12 mm border on each side of the shape, and therefore the sheet would have a width of 126 mm. The borders for the cut pieces of rubber forming the inner layers allow for the exterior fabric material layers to be folded inward and secured to one another, as explained below.

According to another step in the method, the inner noisemaking layer is cut to the approximate shape of the character to be depicted, and is placed between the cut rubber sheets or on top of a single sheet of the cut rubber if only one rubber sheet is used. As mentioned, the inner noisemaking layer may include one or more layers of material such as crackle paper.

According to another step in the method, the inner cut rubber sheets are glued to the inside surfaces of the front and rear exterior layers, such as by a polyurethane latex based adhesive. The rubber sheets may be glued at various locations to the inside surfaces, to include the periphery of the exterior cloth layers and selected locations inside the periphery.

According to another step in the method, the rubber sheets are placed back to back and are aligned with one another. The peripheral edges of the inner and exterior fabric layers may be folded inward from the peripheral edges, and then each of the fabric layers and the crackle layers are stitched or sewn together, thereby providing a stitched or seamed connection along the periphery of the pet toy. As necessary, the peripheral edge of the pet toy may have a single or multiple stitches or seams in order to adequately secure the layers of material together. The one or more stitches or seams along the periphery of the pet toy may also capture the peripheral edges of the sheets of rubber so that each of the layers are secured to one another along the periphery of the pet toy.

According to another step in the method, decorative features may be placed on the exposed exterior surfaces of the pet toy so that the pet toy depicts the intended character. For example, other types of fabric may be used to depict features such as eyes, ears, nose, mouth, hands, feet, etc. Additionally, stitched or embroidered patterns may depict these features or others.

According to another step in the method, an internal pocket or sleeve is provided in order to retain a squeaker. One way in which to incorporate an internal pocket is to cut an opening in the rear exterior layer. A separate pocket-shaped piece of fabric is then placed through the opening and sewn to the opening in order to form the internal holding pocket or enclosure to hold the squeaker. Hook and pile material may be sewn at the opening of the pocket to provide a means to selectively open and close the pocket. The squeaker may be replaced by simply opening the pocket, removing the existing squeaker, replacing it with a new squeaker, and closing the pocket again.

Considering the above features and aspects of the invention, the invention in one embodiment may therefore be considered a multilayered pet toy. The multilayer pet toy comprises, but is not limited to, an exterior fabric layer; at least one inner noisemaking layer disposed interiorly of the exterior fabric layer; and at least one inner elastomeric layer disposed interiorly of the exterior fabric layer.

A number of optional features may be added to this embodiment of the pet toy, to include at least one inner fabric layer disposed interiorly of the exterior fabric layer. The at least one inner noisemaking layer may be made from a non-fabric material. The exterior fabric layer may be sized to cover exposed surfaces of the pet toy, and the exterior fabric layer may include at least one group of stitches used to interconnect the exterior fabric layer with at least one other layer of the pet toy. Additionally, the at least one inner noisemaking layer may be made from a thermoplastic material. In one embodiment, each of the layers extends substantially parallel to one another. The pet toy may further include an internal holding pocket formed within the pet toy and a noisemaking element placed within the internal holding pocket The internal holding pocket may be positioned between two inner elastomeric layers. The toy optionally further includes at least one decorative feature formed on the exterior fabric layer, the at least one decorative feature including at least one of eyes, ears, a nose, a mouth, and hair. The exterior fabric layer may comprise a plurality of different types of fabrics incorporated therein. In one embodiment of the pet toy, the exterior fabric layer comprises at least one of corduroy fabric or oxford fabric and the inner elastomeric layer comprises at least one of natural rubber, synthetic rubber, or combinations thereof. Additionally, the pet toy may have substantially flat exposed opposing surfaces with a substantially uniform thickness extending between the opposing surfaces. Each of the layers may be flexible, planar, sheet-like pieces of material.

In yet another embodiment, the invention may be considered a method of making a pet toy. This includes, but is not limited to, a method generally comprising: (1) providing an exterior fabric layer, at least one inner noisemaking layer, and at least one inner elastomeric layer; (2) arranging the at least one inner noisemaking layer and the at least one inner elastomeric layer within the exterior fabric layer, wherein each of the layers extends substantially parallel to one another; and (3) stitching selected parts of each of the layers to assemble the pet toy.

Additional optional aspects of this method may include: providing at least one inner fabric layer; using adhesive to selectively attach parts of at least one layer to another layer; or wherein the pet toy is shaped to have substantially flat exposed opposing surfaces with a substantially uniform thickness extending between the opposing surfaces. The method may further include: forming an opening through one or more of the exterior fabric layer and the inner elastomeric layer; placing an internal holding pocket through the opening to an interior of the pet toy; sewing the pocket to at least one of the layers of the pet toy; and placing a noisemaking element within the internal holding pocket.

Additional aspects and features of the invention will become apparent from review of the following detailed description, taken in conjunction with a review of the drawings.

### BRIEF DESCRIPTION OF THE DRAWINGS

FIG. 1 is a front view of the pet toy of the invention according to a preferred embodiment;

FIG. 2 is a rear view of the pet toy of the invention according to the preferred embodiment;

FIG. 3 is an enlarged fragmentary cross-sectional view, showing inner details of the pet toy to include the multiple layers making up the pet toy;

FIG. 4 is a greatly enlarged fragmentary cross-sectional view of the pet toy further showing the inner details of the pet toy to include the multiple layers;

FIG. 5 is another greatly enlarged fragmentary cross-sectional view of the pet toy further showing the inner details of the pet toy to include the multiple layers in an alternate embodiment or configuration; and

FIG. 6 is a partial enlarged fragmentary rear view of the pet toy showing an internal holding pocket or sleeve formed in the pet toy to receive and hold a noisemaking device such as a squeaker.

### DETAILED DESCRIPTION OF THE INVENTION

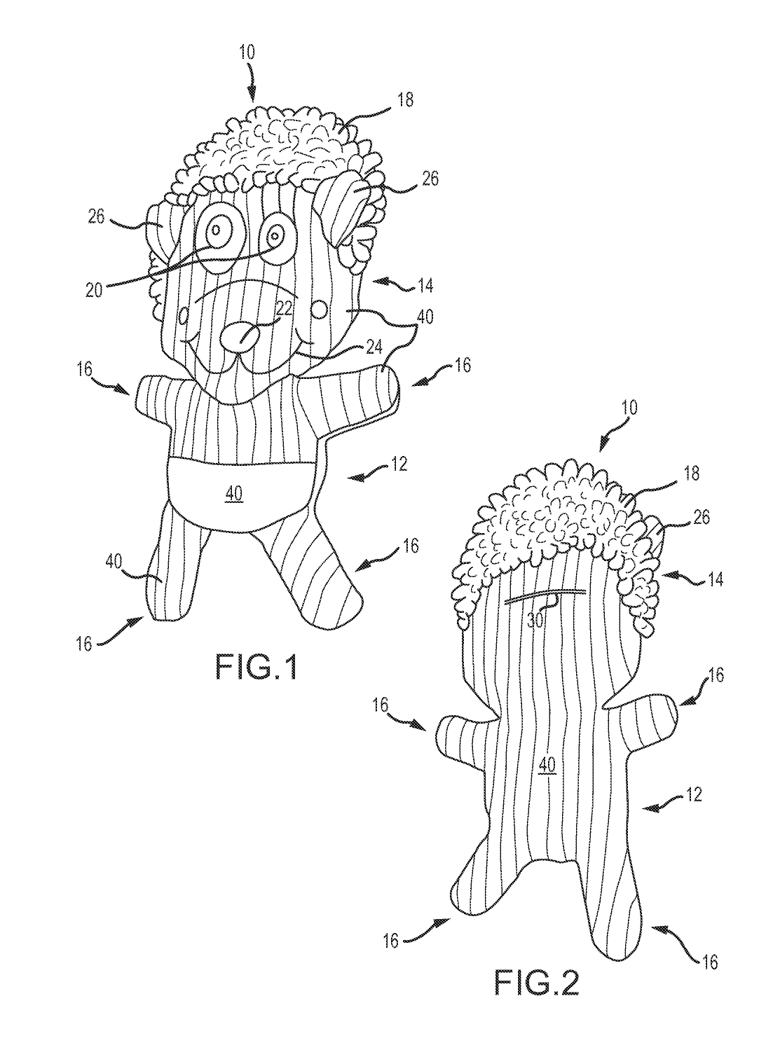

FIG. 1 illustrates the pet toy 10 of the invention in one preferred embodiment. As shown, the pet toy 10 depicts a doll-like figure, and features of FIG. 1 include a body 12, a head 14, and appendages 16 representing arms and legs. Various features on the head as shown include hair 18, eyes 20, a nose 22, a mouth 24, and ears 26. Features such as the eyes 20, nose 22, and mouth 24 may be formed as by stitching or embroidery upon an outer fabric layer 40. As mentioned, the outer fabric layer 40 may include corduroy, oxford, or other fabric types that have a relatively rough or pronounced texture. As also shown, the outer fabric layer 40 may include more than one type of fabric, FIG. 1 illustrating a different type of fabric around the mid-section of the doll like figure. The hair 18 is depicted as yet a different type of fabric material with tufts or loops. One may appreciate from a review of FIG. 1 that the exterior surface of the pet toy 10 provides an animal with different exterior surface textures which may serve to further attract the animal. It will also be appreciated by one of skill in the art that any number of different types of fabric may be used to form the outer fabric layer 40. Accordingly, each of the body 12, the head 14, and each appendage 16 of the pet toy 40 may be formed of different types of fabric.

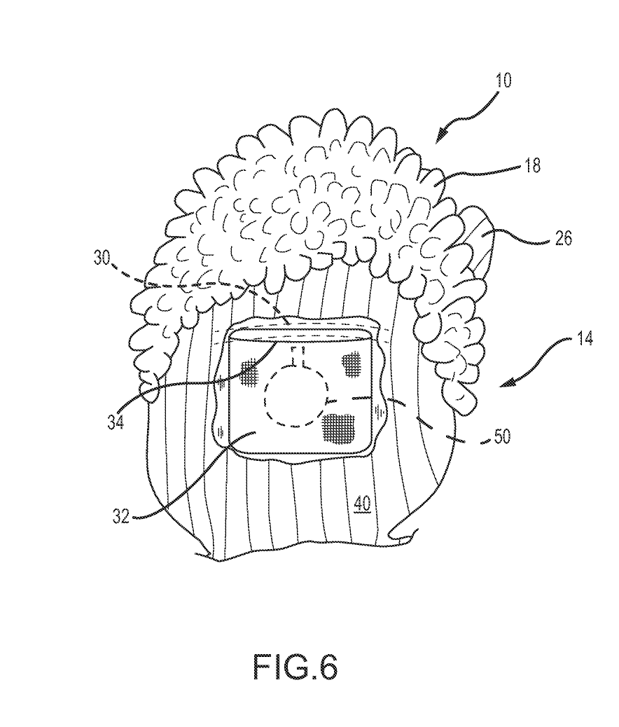

Referring also to the rear view of FIG. 2, an opening 30 is formed by a separation or cut in the outer fabric layer 40 and optionally at least one of the inner elastomeric layers 46. As discussed below with respect to FIG. 6, this opening 30 communicates with an inner holding pocket or sleeve 32 that holds a noise making element such as a squeaker 50.

The pet toy 10 has generally flat exposed surfaces, with a substantially uniform thickness. The thickness of the pet toy 10 is preferably thick enough to enable an animal such as a dog to easily bite and hold the pet toy. For example, according to one preferred embodiment, the pet toy 10 may be between about one 1/2 inch thick to about 1 and 1/2 inch thick.

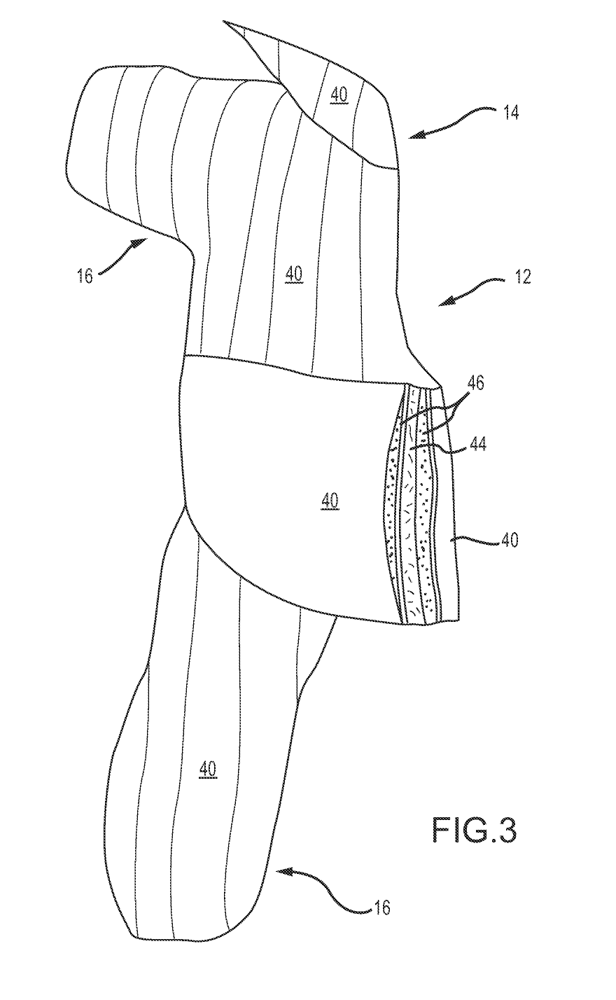

Referring to FIG. 3, inner details of the pet toy are illustrated with respect to the multiple layers making up the pet toy. In the embodiment of FIG. 3, the multiple layers include the outer fabric layers 40 that cover the exposed surfaces of the pet toy, one or more inner noisemaking layers 44 that reside interiorly of the outer fabric layer, and two inner elastomeric layers 46 placed back to back to one another. Accordingly, the inner noisemaking layer 44 forms the most interiorly disposed layer of the pet toy. Another conceptual view of FIG. 3 is one in which there are front and rear outer fabric layers, two inner elastomeric layers, and a noisemaking layer disposed between the two inner elastomeric layers. However, the arrangement of the inner layers may be varied. In one embodiment, at least one inner noisemaking layer is positioned between the outer fabric layers 40 and at least one inner elastomeric layer 46.

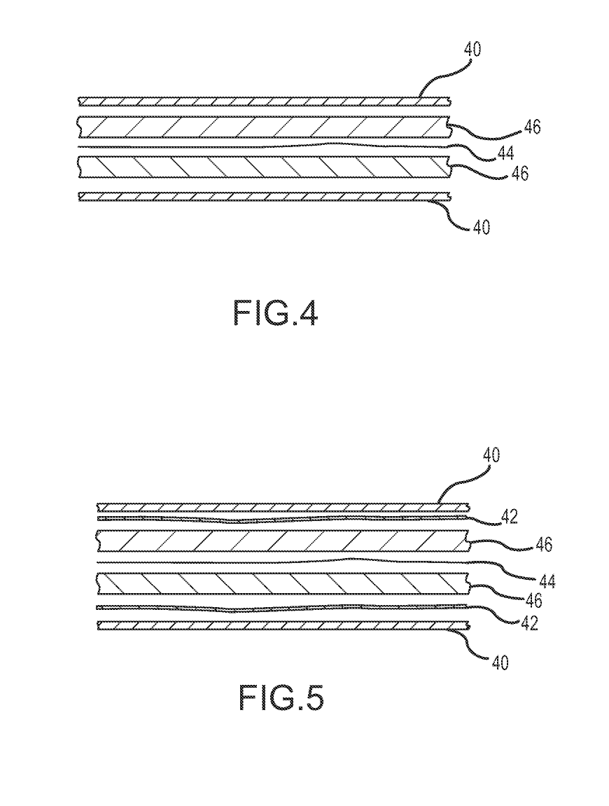

Referring to FIG. 4, this cross-sectional view is provided to further show the multiple layers of the pet toy from FIG. 3, and relative thicknesses of the layers according to one preferred embodiment. As shown in this figure, the inner elastomeric layers 46 are the thickest layers and the inner noisemaking layer(s) 44 are the thinnest layer. One advantage of having a relatively thick inner elastomeric layer 46 is that it provides some bulk or size to the pet toy which may encourage an animal to bite and chew on the toy in order to satisfy the animal's natural urge for chewing. The bulk provided by the elastomeric material also eliminates a need for providing bulk through other materials such as traditional polyester stuffing. While relative thicknesses are shown in FIG. 4, it shall be understood that the invention is not limited to any particular thicknesses for any of the material layers.

Although traditional stuffing may be avoided, in yet another aspect of the invention, material such as plastic polyester film used for the inner noisemaking layer can be crumpled or folded and placed in selected areas within the outer fabric layer to provide yet additional noise making features of the invention. Further, if it is desired to provide yet additional bulk to the pet toy, the crumpled or folded plastic polyester film may achieve this purpose by placing it in selected areas such as the appendages or narrower portions of the pet toy. Alternatively, one of the inner elastomeric layers 46 may be thicker than the other elastomeric layer 46 to provide additional bulk to selected areas of the pet toy.

Referring to FIG. 5, another preferred embodiment is illustrated that includes at least one inner fabric layer 42. This figure more specifically shows two inner fabric layers 42 that reside against the inner surfaces of the outer fabric layer 40. These inner fabric layers 42 are shown as being thinner than the outer fabric layers 40.

Referring to FIG. 6, this fragmentary cross-sectional view illustrates how the inner holding pocket or sleeve is arranged to receive the noisemaking device 50. As shown, the pocket/sleeve 32 is a separate piece of material which may be secured within the interior of the pet toy, such as between the outer fabric layer and the inner elastomeric layer(s). The upper edges 34 of the pocket/sleeve 32 may be sewn to the corresponding edges of the opening 30. An opening may also be formed in one or more of the inner fabric layer 42, the inner elastomeric layer 46, and the noisemaking layer 44 corresponding with the opening 30 in the outer fabric layer 40. In this manner, the pocket/sleeve 32 and the squeaker 50 may be positioned within the interior of the pet toy 10 to better protect the squeaker from damage. Additionally, hook and pile material (not shown) may be sewn to the edges of the opening 30 in order to provide a closure for the pocket/sleeve 32. The pocket/sleeve 32 may be opened and resealed when replacing the squeaker 50.

According to another preferred embodiment of the invention, the central portion or area of the pet toy, such as the body 12, may include the multiple layers of material, while certain decorative features of the pet toy comprise separate pieces of material that are sewn, glued, or otherwise secured to the central portion of the pet toy. For example, the central portion of the pet toy may include simple shapes such circular, oval, or rectangular shapes that incorporate the multiple layers of material. Decorative features such as arms, legs, feet, hands, and/or a head may be made of a single or multiple layered materials and then secured to the central portion of the pet toy. According to this embodiment, manufacturing of the pet toy may be further simplified since the multiple materials are cut in common shapes, which may facilitate simpler stitch or glue patterns to be applied to the multiple layered materials which in turn may further simplify manufacturing.

According to a method of the invention, the pet toy 10 is made with construction steps that are easy to achieve without the need for complex manufacturing equipment, or other requirements that may otherwise significantly contribute to the cost of making the pet toy.

According to one method, the various layers of the pet toy are cut to desired shapes corresponding to the figure to be depicted. The outside or exterior fabric layer 40 of the pet toy may be slightly larger than the other layers. The larger size of the fabric layers 40 enables the exterior facing edges of the exterior layer 40 to be folded inward, such that a stitch line may be used to connect the layers to one another. In one embodiment, the noisemaking layer 44 may be disposed exteriorly of the inner elastomeric layer(s) 46. In another embodiment, the noisemaking layer 44 may be disposed between two inner elastomeric layers 46, and in this latter embodiment, the elastomeric layers may therefore serve to better protect the noisemaking layer 44 from damage. Adhesive may be used to connect one or more layers of the pet toy 10, such as the outer surfaces of the inner elastomeric layers 46 that contact the inner surfaces of the outer fabric layer 40 or the inner fabric layer 42. Decorative features may be secured to the exposed exterior surfaces of the pet toy, and these features may include stitched or embroidered patterns of other types of fabric fibers. The internal pocket or sleeve 32, preferably made from a separate piece of fabric, is placed through an opening 30 in the outer fabric layer 40, and is then secured to the edges of the opening. Optionally, the opening 30 may extend through one or more of the inner fabric layer 42, an inner elastomeric layer 46, and the noisemaking layer 44. Closure material, such as hook and pile material may be sewn at the opening of the pocket to provide a simple but effective means to selectively open and close the pocket.

From the foregoing, it should be apparent that the pet toy of the invention provides multiple different characteristics that may better attract and hold the attention of an animal as compared to traditional plush or rubber toys. The inner elastomeric layer(s) provide a flexible and elastic characteristic so that when the animal bites on the toy, it functions as a rubber type of toy to satisfy the need for the animal to chew. The exterior fabric layer has decorative features which may further attract the animal, and may be aesthetically pleasing to the pet owner for purposes of purchasing the toy. The decorative features in combination with various fabric types provide different textures or “feels” for the toy, which may further attract the animal to interact with the toy. The inner noisemaking layer generates a distinct crinkling or crackling sound which may further stimulate the animal. The squeaker placed within the inner of the toy provides yet another stimulating feature for the animal. The multiple stimulating characteristics of the pet toy are provided within a simple and reliable construction.

While the foregoing invention has been described in particular detail with respect to one or more preferred embodiments, it shall be understood that various changes and modifications of the invention are contemplated commensurate with the scope of the claims appended hereto.

What is claimed is:

1. A multilayered pet toy comprising:
an outer fabric layer;
at least one inner noisemaking layer disposed interiorly of the outer fabric layer; and
at least one inner elastomeric layer disposed interiorly of the outer fabric layer.

2. A multilayered pet toy according to claim 1, wherein:
said at least one inner noisemaking layer is made from a non-fabric material.

3. A multilayered pet toy according to claim 1, wherein:
said outer fabric layer covers exposed surfaces of the pet toy, and said outer fabric layer includes at least one group of stitches used to interconnect the outer fabric layer with at least one other layer of the pet toy.

4. A multilayered pet toy according to claim 1, wherein:
said at least one inner noisemaking layer is made from a thermoplastic material.

5. A multilayered pet toy according to claim 4, wherein:
said thermoplastic material comprises plastic polyester film.

6. A multilayered pet toy according to claim 1, wherein:
each of said layers extends substantially parallel to one another.

7. A multilayered pet toy according to claim 1, further including:
an internal holding pocket formed within said pet toy; and
a noisemaking element placed within said internal holding pocket.

8. A multilayered pet toy according to claim 7, wherein:
said at least one inner elastomeric layer includes two inner elastomeric layers; and
said internal holding pocket is disposed between said two inner elastomeric layers.

9. A multilayered pet toy according to claim 1, further including:
at least one decorative feature formed on said outer fabric layer, said at least one decorative feature including at least one of eyes, ears, a nose, a mouth, and hair.

10. A multilayered pet toy according to claim 1, wherein:
said outer fabric layer comprises a plurality of different types of fabrics incorporated therein.

11. A multilayered pet toy according to claim 1, wherein:
said outer fabric layer comprises at least one of corduroy fabric or oxford fabric.

12. A multilayered pet toy according to claim 1, wherein:
said inner elastomeric layer comprises at least one of natural rubber, synthetic rubber, or combinations thereof.

13. A multilayered pet toy according to claim 1, further including:
at least one inner fabric layer disposed interiorly of said outer fabric layer.

14. A multilayered pet toy according to claim 1, wherein:
said pet toy has substantially flat exposed opposing surfaces with a substantially uniform thickness extending between said opposing surfaces.

15. A multilayered pet toy according to claim 1, wherein:
each of said layers comprises a flexible, planar, sheet-like piece of material.

16. A multilayered pet toy according to claim 1, wherein:
said at least one inner elastomeric layer includes two inner elastomeric layers, and said at least one inner noisemaking layer is disposed between said two inner elastomeric layers.

17. A method of making a pet toy, comprising:
providing an outer fabric layer, at least one inner noisemaking layer, and at least one inner elastomeric layer;
arranging the at least one inner noisemaking layer, and the at least one inner elastomeric layer within the outer fabric layer;
stitching selected parts of each of said layers to assemble the pet toy; and
wherein each of said layers extends substantially parallel to one another.

18. A method of making a pet toy, according to claim 17, further including;
providing at least one inner fabric layer disposed within the outer fabric layer.

19. A method of making a pet toy, according to claim 17, further including;
using adhesive to selectively attach parts of at least one layer to another layer.

20. A method of making a pet toy, according to claim 17, wherein:
said pet toy is shaped to have substantially flat exposed opposing surfaces with a substantially uniform thickness extending between said opposing surfaces.
